(19) United States
(12) Patent Application Publication
(10) Pub. No.: US 2004/0112673 A1
(43) Pub. Date: Jun. 17, 2004

(54) Rescue system and spacer therefor

(76) Inventor: Amos Bodinger, Kiryat Bialik (IL)

Correspondence Address: NATH & ASSOCIATES PLLC, Sixth Floor, 1030 15th Street, N.W., Washington, DC, 20005, US

(21) Appl. No.: 10/704,142

(22) Filed: Nov. 10, 2003

(30) Foreign Application Priority Data
Dec. 15, 2002 (IL) 153444
Jul. 2, 2003 (IL) 153444/2

(51) Int. Cl. A62B 1/16

(52) U.S. Cl. 182/6

(57) ABSTRACT

A rescue system comprising a spacer for protecting a rescuee during decent from a skyscraper along a cable, the spacer being activated by an arrangement that is actuated as a result of attaining a predetermined speed of descent or predetermined distance of descent.

### FIELD OF THE INVENTION

This invention relates to rescue systems for rescuing people from high places in times of emergency.

### BACKGROUND OF THE INVENTION

In emergency situations, when people must be safely rescued from high places such as skyscrapers, its height raises a challenge to the emergency services and may thus require the use of specially designed rescue equipment.

Such special equipment may be needed in situations such as terror attack, fire, earthquakes and the like, especially when the traditional means of escape, such as fire-escapes or sliding-sleeve escapes, are not available or are not functioning.

The difficulty of escape is enhanced if rescuees must escape from upper floors of skyscrapers, as fire ladder capability is typically limited to thirty six meters and other conventional rescue equipment do not efficiently reach the uppermost floors. This problematic situation was extraordinarily demonstrated during the terrorist act at the World Trade Center buildings on Sep. 11, 2001. The fact that the rescue services were unable to rescue people from the top floors with their standard equipment was confirmed.

Several methods and devices are known for rescuing people from uppermost floors of skyscrapers. These generally incorporate a descent mechanism comprising a rope, strap, steel cable or the like, lowered from the skyscraper to facilitate descent of rescuees adjacent the walls of the skyscrapers.

Such methods are disclosed inter-alia, by “R.E.D.E. Inc.” in the firm's web-site: www.rederescue.com, by the firm “Resqline” in its web-site www.resqline.com and by the firm “LifeCender” presenting the system. “PLC-80” in its web-site www.lifecender.com. Some systems use special fittings for controlling descent rate such as a mechanical speed-restraining member associated with a pulley-wheel as distributed by the firm “Protecta International”, under the trade name “Rollgiss R200”.

### SUMMARY OF THE INVENTION

The present invention relates to equipment for the protection of a rescuee for use in a rescue system for rescuing a person (rescuee) from a tall building or structure in the form of a spacer designed to keep the rescuee away from the building or the structure, (hereinafter in the specification and claims referred to as a “skyscraper”).

The spacer is particularly useful in association with a rescue system in which a rescuee descends along a cable, or the like, adjacent a wall of the skyscraper, to protect the rescuee from the contact with such wall and/or structures that may injure the rescuee.

The term cable is used in the specification and claims in its broadest sense and includes items such as rope, strap, wire, strip, cord, string, line and so forth.

The spacer is designed to be activated by an arrangement that is actuated as a result of attaiing a predetermined speed of descent or predetermined distance of descent and typically is activated automatically at the onset of descent.

According to one embodiment, the spacer is an inflatable device that typically is located above the rescuee during descent. The device may be inflated by means analogous to that which inflates automobile airbags—typically by an electric signal.

According to another embodiment the spacer is a frame construction which is folded prior to descent and automatically opens to provide protection to the rescuee. The frame construction is typically opened automatically by a mechanical means.

According to yet another embodiment of the invention, there is provided a rescue system incorporating the above-described spacer.

### BRIEF DESCRIPTION OF THE DRAWINGS

In order to understand the invention and to see how it may be carried out in practice, some embodiments will now be described, by way of non-limiting examples only, with reference to the accompanying drawings, in which:

FIG. 1 is a general view of a rescuee with a personal rescue system comprising a spacer according to one embodiment of the present invention;

FIG. 2 is a general view of a rescuee with a personal rescue system comprising a spacer according to another embodiment of the present invention;

FIG. 3 is a front view of the spacer shown in FIG. 2 in a closed configuration;

FIG. 4 is an enlarged view of an activating mechanism of the spacer shown in FIG. 2; and

FIG. 5 is a cross-sectional front view of one example of a cable out-haul mechanism of the personal rescue system of the present invention, shown in FIGS. 1 and 2.

### DETAILED DESCRIPTION OF THE INVENTION

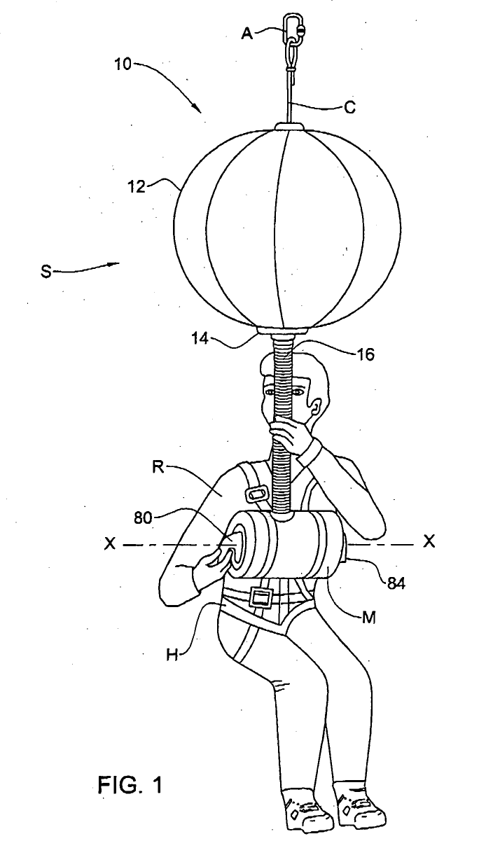

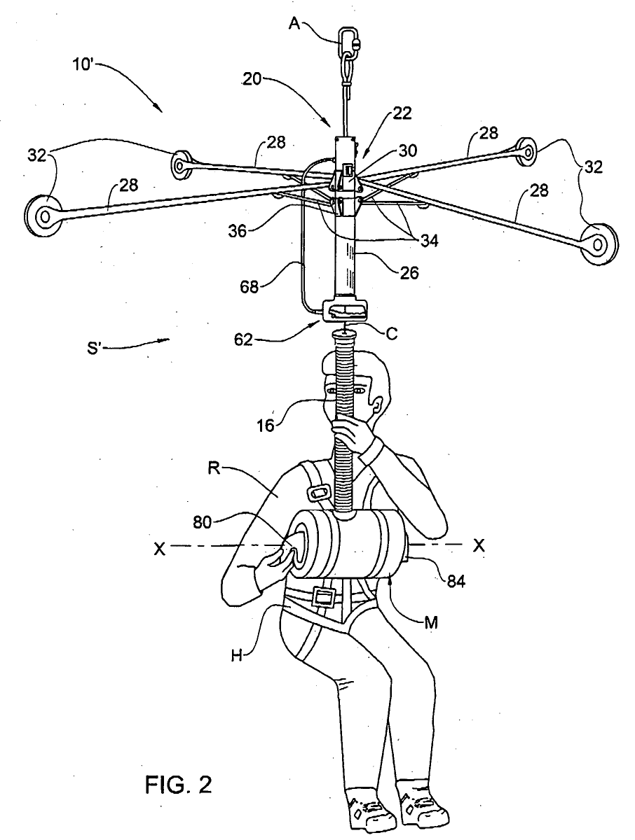

Referring to FIGS. 1 and 2, there are illustrated examples of personal systems S and S′, respectively, for rescuing a rescuee R from a skyscraper (not shown) in which a spacer 10 (FIG. 1), 10′ (FIG. 2) of the present invention is used. The rescue systems S and S′ comprise several components common to such systems including a harness H, an out-haul mechanism M attached thereto, a rope or cable C, whose one end is associated with the mechanism, an anchoring arrangement A (shown here as a carabineer) attached to the other end of the cable and an elastic sleeve 16, extending between the spacer 10, 10′ and the mechanism M.

FIG. 1 shows the spacer 10, in. accordance with one embodiment of the invention. The spacer 10 is an inflatable device 12 essentially in the form of a large ball, having a passageway therethrough (not seen), with a base 14 fixedly connected to the upper end of the elastic sleeve 16. The inflatable device 12 is stored non-inflated, typically folded, prior to use and is inflated at the onset of descent, as described hereinbelow. More than one inflatable device 12 may be used.

The spacer 10 and sleeve 16 are designed such that they typically are located above the rescuee R during descent, as seen in FIG. 1. The cable C passes through the center of the spacer S.

The inflatable device 12 may be inflated, for example, by the release of gas from a chemical reaction such as used in automobile airbags, from a compressed gas source, and so forth. The release of gas can be initiated by a variety of means such as an electric signal or a mechanical arrangement, as detailed below.

The spacer 10 further comprises a disconnecting member (not seen) that disconnects the inflatable device 12 from the elastic sleeve 16 when necessary. This may be required, for example, when the sleeve is overloaded, to allow the rescuee R to continue descent, even if the spacer 10 get stuck or hung up on an obstacle. The disconnect member can be a component analogous to that used for disconnecting from parachutes or a device activated by the weight of the rescuee R or the like, thereby enabling the rescuee R to descend without the spacer 10.

Thus, the spacer 10 provides an area of safety during descent of the rescuee R without taking up a significant amount of space prior to use and it is activated automatically at the onset of descent. The spacer 10 is typically spherical, however it may be any of a variety of shapes—preferably one that facilitates passage over obstacles while protecting the rescuee R. The shape of the spacer 10 and the fact that it is an inflated structure allow for smooth descent with little chance for getting hung up on obstacles and minimal hanging or shaking of the rescuee R.

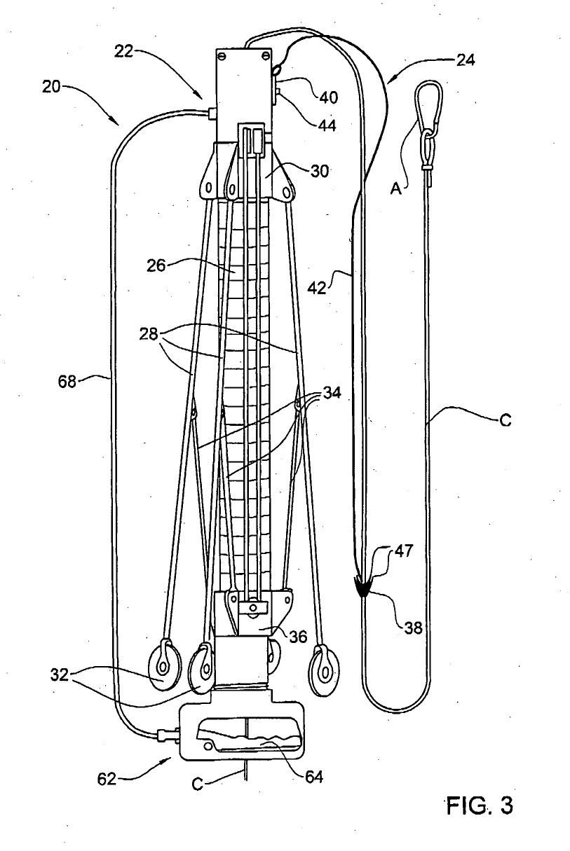

In FIGS. 2-4 another embodiment of a spacer 10′ of the present invention is illustrated. The spacer 10′ comprises a foldable frame construction 20 and an activating mechanism 22 associated with a sliding actuator 24 (FIG. 3). The frame construction 20 is seen in FIG. 2 in its open. unfolded state, wherein the spacer 10′ has been activated, and in FIG. 3 in its folded or closed state.

The frame construction 20 has a central pole 26 with four side arms 28 pivotally connected thereto via a fixed ring 30 assembled on the central pole. The central pole 26 is hollow allowing the cable C to pass therethrough.

At the free end of each side arm 28 is a roller 32, rotatably attached thereto, for reducing the friction between the spacer 10′ and any obstacles/rigid objects that might be encountered during descent. This may be achieved by other means (not shown) such as balls made of a low friction material, semi-rigid tongues, and so on.

A spoke 34 is pivotally connected to each of the side arms 28 and to a sliding ring 36 slidingly disposed around the central pole 26, so as to form an umbrella-like arrangement. Thus, when the fixed ring 30 and the sliding ring 36 are spaced apart, the side arms 28 and the spokes 34 are positioned adjacent the central pole 26 and substantially parallel thereto so that the spacer 10′ is in a closed state (FIG. 3). However, when the rings 30 and 36 are drawn toward each other, the side arms 28 are pulled away from one another and from the central pole 26 to a position substantially angled thereto in an open state, and the spacer 10′ is activated (FIG. 2).

The sliding actuator 24 (FIG. 3), is designed to activate the spacer 10′ upon descent of the rescuee R, by opening the frame construction 20. The sliding actuator 24 comprises a sliding member 38, a locking member 40 and a string 42 of a predetermined length, connecting therebetween. The locking member 40 secures a pin 44 at an opening 46 located in the central pole 26. The sliding member 38 preferably has sharp protusions 47 to catch on a stopping point such as a window sill (not shown) at the onset of descent.

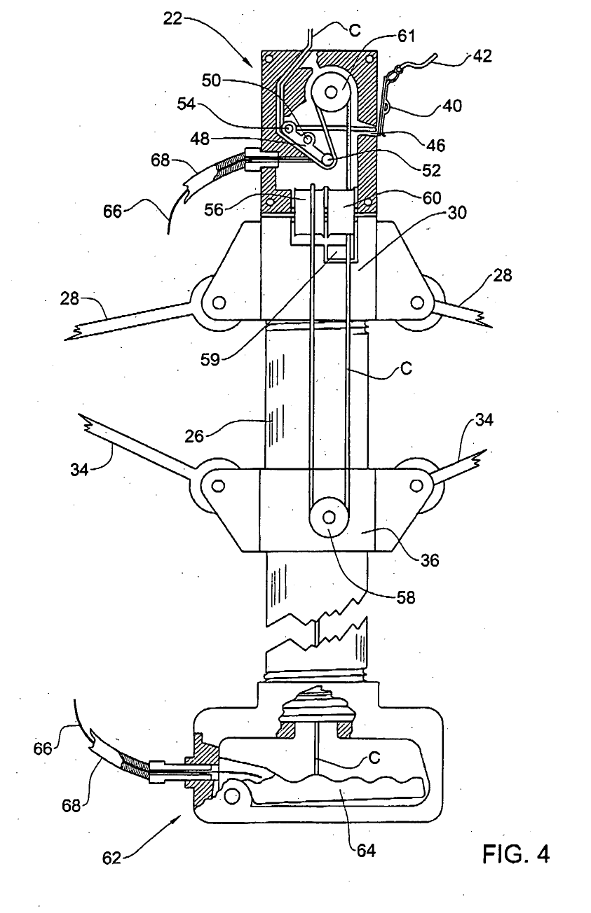

Referring now to FIG. 4, further details of the activating mechanism 22, which is disposed in an upper portion of the central pole 26, are seen. Here the locking member 40 is shown removed from the pin 44, and the pin, which is biased by a means (not shown), such as a spring, is thus allowed to move toward a lug 48. The lug 48 is disposed within the central pole 26 and is pivotally connected thereto at pivot point 50. The lug 48 has a lower end 52 and upper end 54 which corresponds to one end of the pin 44.

The cable C enters the central pole 26 from its bottom end and travels upward and around a rotatable pulley-wheel 56 shown disposed inside the central pole 26. Then the cable C travels downward to wind around a pulley-wheel 58 assembled on the sliding ring 36—outside the central pole 26. From there, the cable C is directed upward and back inside the central pole 26 via a roller 59 and a pulley-wheel 60, onward around yet another pulley-wheel 61, again downward where it travels around the lower surface of the lug 48, and upward where it exits the central pole 26.

Prior to descent of the rescuee R, the frame construction 20 is folded in the closed state as shown in FIG. 3. Upon descent, the sliding member 38 of the sliding actuator 24 starts sliding on the cable C until it reaches a stopping point, such as a window ledge or a knot in the cable and the like (not shown), which blocks its sliding.

At this point, the rescuee's weight pulls on the string 42 causing removal of the locking member 40 from the pin 44, enabling the pin to press on the lug 48. In turn, the lug 48 presses on the cable C increasing the fiction thereon causing the sliding ring 36 to be pulled toward the fixed ring 30, thereby opening the frame construction 20. Thus, the spacer 10′ is activated to a configuration as illustrated in FIG. 2. The cable C continues to slide through the central pole 26, albeit with higher tension.

It should be understood that there are many mechanisms conceivable for automatically opening the frame construction 20 at a point when descent commences and the mechanism described herein is only one of many alternatives.

The frame construction 20 can be folded if needed or desired, by using a mechanism 62 at the bottom of the central pole 26. The mechanism 62 comprises a lever 64 associated with a wire 66 disposed in a sleeve 68. The upper end of the sleeve 68 is connected to the activating mechanism 22 of the frame construction 20 and its lower end is connected thereto adjacent the lever 64.

The wire 66 is secured to the lever 64 at its bottom end and to the lower end 52 of the lug 48 in its upper end. When the lever 64 is depressed, the wire 66 is pulled, thereby pulling the lower end 52 of the lug 48 that rotates around the pivot point 50. This decreases the friction between the cable C and the upper end 54 of the lug 48 and thus, in a process opposite to the opening of the frame construction 20 (activation of the spacer 10′), the construction can be folded. If the lever 64 is released (not depressed) during descent, the spacer 10′ is reactivated.

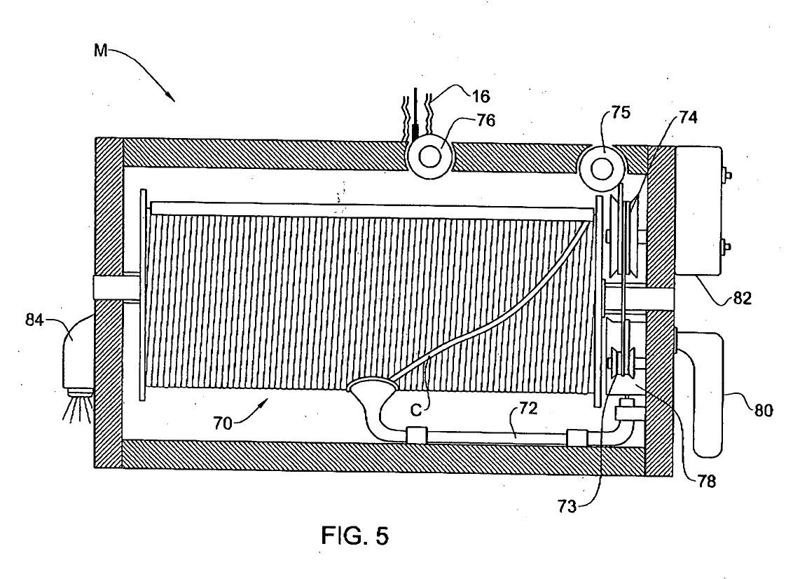

Attention is now directed to FIG. 5 illustrating the out-haul mechanism M, which is barrel-shaped and has a longitudinal axis of symmetry X essentially perpendicular to the direction of descent.

Within the out-haul mechanism M is a spool 70 around which the cable C is wound. The cable C is directed via a tube 72 to a series of pulley-wheels 73, 74, 75 and 76 that direct the cable out of the top of the out-haul mechanism M and into sleeve 16. The cable C also passes a friction member 78 which is movable by a handle 80 whereby the rescuee R can slow or stop descent if warranted.

Pulley-wheel 74 is associated with a generator 82 that produces electricity when the wheel rotates; i.e. during descent. The electricity produced may be used as a means to signal the activation of the spacer 10—for example actuating an airbag-like inflation arrangement. The rescue system S is typically designed such that at a predetermined speed of descent the generator 82 produces enough electricity to signal the inflation thereby activating the spacer 10. Thus, the spacer 10 can be activated at an appropriate time without need for input from the rescuee R.

Electricity produced may also be used to power an illuminating device 84 which is especially useful if rescue takes place at night.

After the cable C is anchored, the rescuee R may then start descending along the cable C thereby out-hauling the cable from the out-haul mechanism M. The descent speed can be controlled automatically by any of a number of methods as known, that is safe for the rescuee R and yet results in a reasonable rescue time; and, the rescuee R can decrease or stop descent by using the handle 70.

Thus, typically at the onset of descent, the generator 82 or string 42 actuates an arrangement (e.g. airbag-like device or sliding actuator 24, respectively) thereby activating the spacer 10 or 10′ upon attaining a predetermined speed or distance of descent, respectively, as described above. Alternatively, the spacer 10 or 10′ may be activated by other means, for example, by a tachometer associated with the generator 82 or one of the pulley-wheels, 56, 58, 60 or 61, which may determine the distance and/or speed of descent.

The rescue system S or S′ is particularly useful in cases where the rescuee R is not in a fully functioning state (unconscious, injured, in shock, etc.) as once the harness H is outfitted on the rescuee, with help if necessary by a person who may then launch the rescuee's descent, the rescuee descends safely at a moderate rate, spaced apart from rigid objects by the automatically activated spacer 10 or 10′.

Alternatively, spacer 10, 10′ could remain stationary after opening at the onset of descent—rather than accompanying the rescuee R. In such an embodiment, an area of protection is regardless formed between the rescuee R and the wall of the skyscraper, essentially equal to the radius of the spacer 10, 10′. The spacer 10, 10′ could be held in place via a number of methods, e.g. it can tightly surround the cable C at a point a given distance below the anchoring arrangement A, there could be a knot or other protrusion along the cable, etc.

It should be understood that there are various spacers and rescue systems devisable according to the present invention and that the above description is merely explanatory. Thus, the spacer and rescue system can be embodied in a variety of aspects within the scope of the present invention mutatis mutandis.

1. A spacer for protecting a rescuee during decent from a skyscraper along a cable, the spacer being activated by an arrangement that is actuated as a result of attaining a predetermined speed of descent or predetermined distance of descent.

2. The spacer according to claim 1, wherein the spacer is activated automatically.

3. The spacer according to claim 1, wherein the spacer is activated electrically.

4. The spacer according to claim 1, wherein the spacer is activated mechanically.

5. The spacer according to claim 1, wherein the spacer comprises at least one inflatable device and activating the spacer entails inflating said inflatable device.

6. The spacer according to claim 5, wherein the inflatable device is significantly spherical.

7. The spacer according to claim 5, wherein the inflatable device is inflated with gas released from a chemical reaction.

8. The spacer according to claim 7, wherein the chemical reaction is initiated by an electric signal.

9. The spacer according to claim 8, wherein the electric signal is produced by a generator powered by out-haul of the cable.

10. The spacer according to claim 5, wherein the inflatable device is inflated with gas from a compressed-gas source.

11. The spacer according to claim 1, wherein the spacer is activated upon attaining a predetermined speed of descent and said speed is determined by a pulley-wheel, a generator or a tachometer.

12. The spacer according to claim 1, wherein the spacer is activated upon attaining a predetermined distance of descent and comprises a sliding actuator.

13. The spacer according to claim 12, wherein the sliding actuator comprises a string of a predetermined length extending between an activating mechanism and a sliding member.

14. The spacer according to claim 1, wherein the spacer has associated therewith a disconnecting member designed to disconnect the spacer from the rescuee if the spacer gets hung up on an obstacle during descent.

15. The spacer according to claim 1, wherein the spacer comprises a frame construction.

16. The spacer according to claim 15, wherein the frame construction comprises at least three arms which are movable between a folded configuration and a un-folded open configuration in which the spacer is activated.

17. The spacer according to claim 1, wherein the cable passes essentially through the center of the spacer.

18. The spacer according to claim 1, wherein the spacer descends along with the rescuee.

19. The spacer according to claim 1, wherein the spacer remains essentially stationary above the rescuee.

20. A rescue system for facilitating the descent of a rescuee from a skyscraper comprising a harness and a mechanism for out-hauling a cable, wherein said system further comprises a spacer according to claim 1.
